(19) United States
(12) Patent Application Publication
(10) Pub. No.: US 2003/0226408 A1
(43) Pub. Date: Dec. 11, 2003

(54) Reading device for a tool

(76) Inventor: Chih-Ching Hsien, Feng Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/165,986

(22) Filed: Jun. 11, 2002

(51) Int. Cl. G01L 5/24

(52) U.S. Cl. 73/862.21

(57) ABSTRACT

A reading device for torque tool includes a plurality of reading windows connected to the shank of the tool, and a plurality of marks are located on an outer surface of the handle. Each mark is composed of a notch defined in the outer surface of the handle and each notch has a mark piece 1 received therein.

### FIELD OF THE INVENTION

The present invention relates to a reading device for a torque tool and the device includes multiple reading windows and each mark is embedded under a surface of the handle of the tool.

### BACKGROUND OF THE INVENTION

A conventional reading device for a torque tool is shown in FIG. 1 and generally includes a plurality of marks 30 which is located on the outer surface of the handle 3 of the tool and a reading window 2 is connected to the shank 1 of the tool. The handle 3 is rotatable so as to align one of the marks 30 with the index arrow. The reading window 2 allows the user to read the data of the output torque of the tool. As illustrated in the enlarged drawing, the marks are printed (or by any known method) on the outer surface of the handle 3 so that they are easily to be worn off. Besides, the number of the reading window 2 is only one and the position of the reading window 2 cannot be changed. The position of the reading window 2 could not be convenient for reading especially when the tool is used in a narrow space.

The present invention intends to provide a reading device for a tool wherein the number of the reading windows is multiple and the marks are embedded in the outer surface of the handle so that they are not worn off.

### SUMMARY OF THE INVENTION

In accordance with one aspect of the present invention, there is provided a reading device for torque tool which includes a handle, a shank extending from the handle, and a function end. The reading device comprises a plurality of reading windows connected to the shank of the tool and a plurality of marks are located on an outer surface of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional reading device on a torque tool;

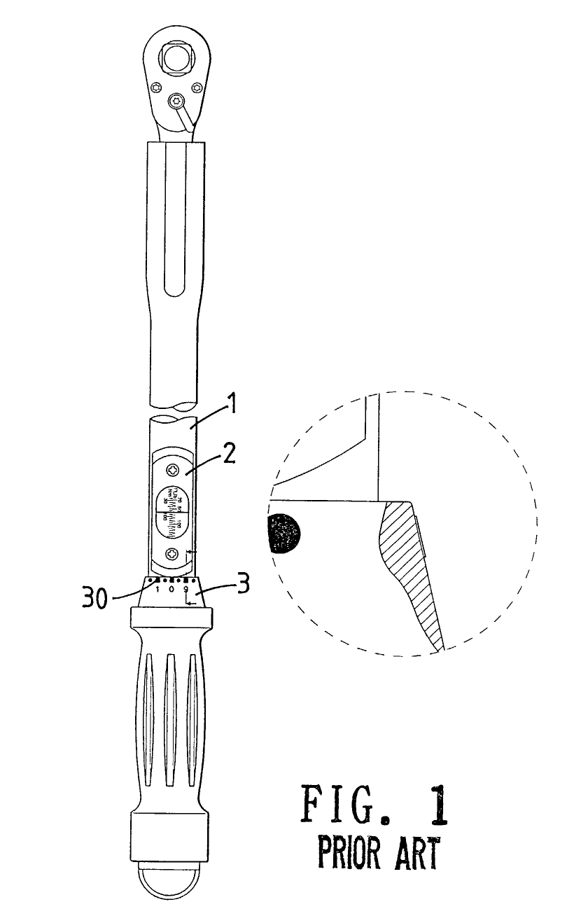

FIG. 2 shows the reading device of the present invention of a torque tool;

FIG. 3 is a perspective view to show the reading device on the torque tool;

FIG. 4 is a perspective view to show that two reading windows are used in the reading device;

FIG. 5 shows the shank may have one, two and three reading windows.

### DETAILED DESCRIPTION OF THE PREFERRED EMBODIMENT

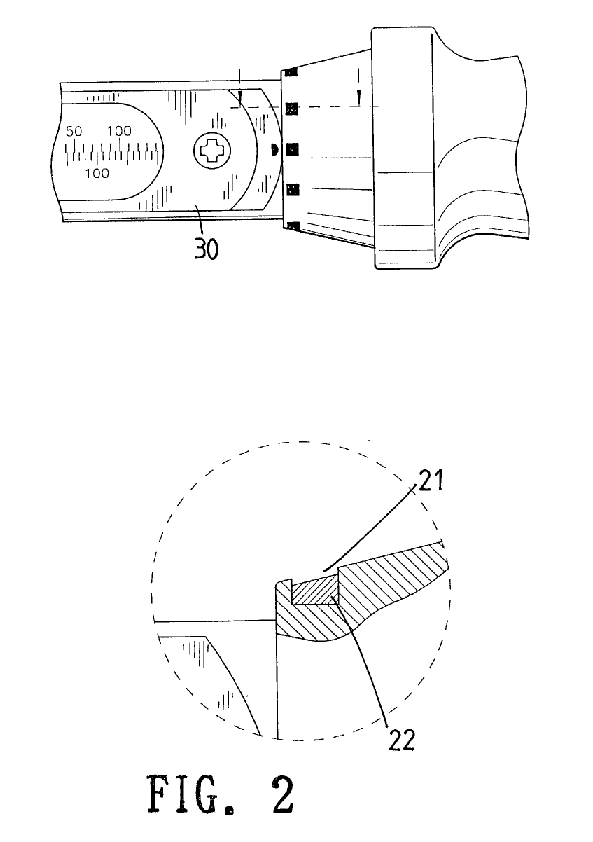

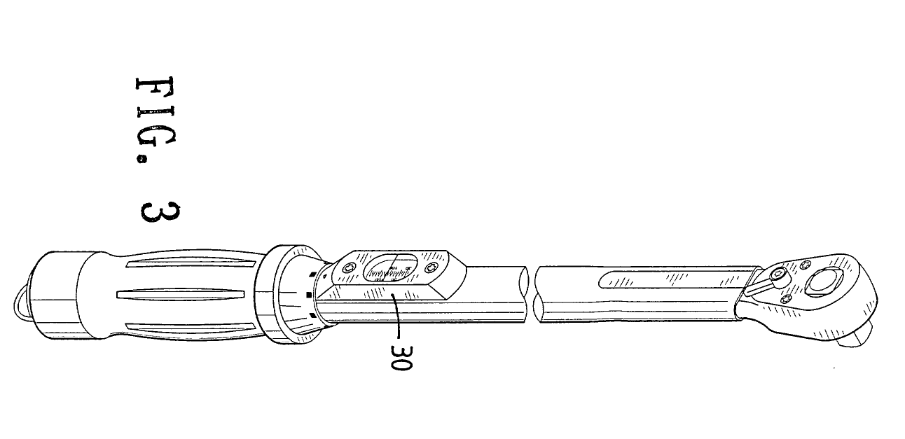

Referring to FIGS. 2 and 3, the reading device for a torque tool 10 of the present invention comprises a plurality of marks located on an outer surface of the handle 20 and each mark is composed of a notch 21 defined in the outer surface of the handle 20 and each notch 21 has a mark piece 22 received therein. The mark piece 21 is located below the outer surface of the handle 20 so that the mark piece 21 is not worn during using the torque tool. A window 30 is connected to the shank of the tool 10 and shows the torque that the tool outputs.

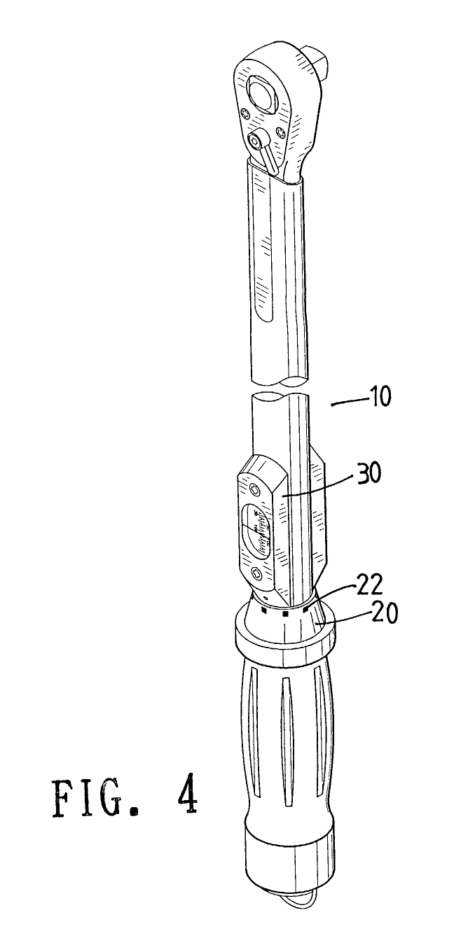

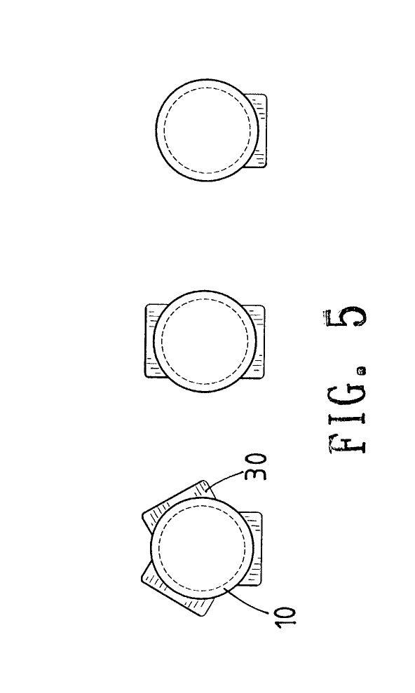

FIG. 4 shows that the number of the reading windows 30 is multiple and the positions of the reading windows 30 can be set to meet the needs of the way of use of the tool 30. The positions of the reading windows 30 can be arranged as shown in FIG. 5 and the reading windows 30 can also be arranged at different horizontal planes such that the users read the data conveniently even if the tool is used in a deep or narrow space.

While we have shown and described the embodiment in accordance with the present invention, it should be clear to those skilled in the art that further embodiments may be made without departing from the scope of the present invention.

What is claimed is:

1. A reading device for torque tool which includes a handle, a shank extending from the handle, and a function end, the reading device comprising:
a plurality of reading windows adapted to be connected to the shank of the tool, and a plurality of marks located on an outer surface of the handle.

2. The reading device as claimed in claim 1 wherein each mark is composed of a notch defined in the outer surface of the handle and each notch has a mark piece received therein.
